(19) United States
(12) Patent Application Publication
(10) Pub. No.: US 2002/0016955 A1
(43) Pub. Date: Feb. 7, 2002

(54) Method and system for constructing a system, drawing a system configuration drawing, and generating a system configuration file

(75) Inventor: Shoichi Matsuo, Yokohama-shi (JP)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY

(21) Appl. No.: 09/886,748

(22) Filed: Jun. 21, 2001

(30) Foreign Application Priority Data
Jun. 29, 2000 (JP) 200-197377

(51) Int. Cl. G06F 9/44

(52) U.S. Cl. 717/2

(57) ABSTRACT

The object of the present invention is to improve working efficiency in system construction works. This is accomplished when a customer 1 makes a request for system construction to a provider of the infrastructure construction service 2, and the service provider 2 conducts a consultation. The service provider 2 uses the e-editor to create a configuration drawing, then sends data that has been input to the e-editor to a server of the configuration file generation service 3. The server automatically generates a configuration file with macro expansion of a template, and then after customization as needed, sending the configuration file back to the service provider. The service provider installs the configuration file in the customer's system.

### FIELD OF THE INVENTION

The present invention relates to a method and system for constructing a system, drawing a system configuration drawing, and generating a system configuration file and a media thereof, and more particularly to a useful technique to be efficiently applied for configuring a computer system such as a network.

### BACKGROUND OF THE INVENTION

The Internet has become an essential basic technology of societies as an information infrastructure for binding not only a company to a company, but a company to an individual and an individual to an individual. In particular, the use of the Internet in a company is considered an essential underpinning for carrying on electronic commerce, such as new market cultivation, customer cultivation, securing of regular customers, intercorporate transactions, etc. Also, for individuals running a business in small and medium-sized companies and small offices, the Internet is considered as an effective tool for connecting with large companies. In this context, it is an acute problem for individuals and enterprises to obtain a system environment matching the Internet for business development. Today the Internet is considered as one of the fundamental social infrastructures, its importance isn't spoiled in nonprofit use of the Internet, such as private use and use of nonprofit businesses. In these social environments, active IT investments are being made and a variety of systems are constructed. Now an example of a technique for system construction will be described.

An IT engineer who possesses the necessary knowledge for system construction receives a request from a customer and conducts a consultation about the system construction according to this request. Then, he designs a logical system (which relates to a configuration of various kinds of services such as a mail, web and application) based on this consultation and a physical system (which relates to a hardware configuration based on the physical conditions, e.g., which service be embodied by which hardware) that embodies this. Furthermore, he decides each environmentally unique value in relation to each hardware component that comprises the system. The environmentally unique values are parameters specific to the operating environment, such as a name of server, IP (Internet Protocol) address, the destination of the DNS (Domain Name Server), etc.

The design of these logical system and physical systems is performed by creating a system configuration drawing. That is, each service that is a logical component is represented by a graphic such as a square, then relations between each service are represented by a line or arrow that connects these graphics. The direction of arrows represents the flow of information, for example. The hardware embodying a service is also represented by a graphic such as a square and arranged to contain each service. A subnet framework and domain framework are entered, which surround graphics representing services and hardware, thereby defining the network. Then, each hardware component is given an environmental unique value such as an IP address, thereby completing the environmental configuration drawing including an operating environment.

Thereafter, preparing the hardware necessary for the system, then connecting the hardware, and installing system software, various kinds of device drivers, and applications or the like. Next the system configuration file for each hardware is created and installed (including the input of environmental unique values), based on the configuration drawing of the operating environment. Then, the operation of the entire system is checked and an adjustment is carried out depending on the operating conditions, such as an addition of users and groups, settings of securities, etc. However, the above system configuration technique has following problems. First, creating a logical or physical system and a configuration drawing of operating environments or the like requires a substantial workload. As mentioned above, as the creation of the configuration drawing is a system design work, which is manually produced. Even with the CAD (Computer Aided Design) software, manual intervention is required to create and position graphics and characters and to draw lines that indicate the relations between services, thus the workload is still large. In particular, when designing a large-sized network system, the elements to be described become huge, including constituent services, hardware, and relations between them, thus the workload significantly increases.

Secondly, when trying to reuse the configuration drawing or the configuration file created for one project with another system configuration, there occurs a significant workload for picking out the changing points. Configuration drawings and configuration files once created are saved as know-how, which is used later for constructing similar systems. However, it is the rare case that the system becomes completely the same, so that there are usually changes required to cope with a new system. In order to cope with these changes rapidly, the points of change specific to that system in the completed configuration drawing and the configuration file are marked in advance, and in addition memos are attached to other associated elements in that system. Making such marks and memos an eyemark, those points to be changed are quickly comprehended and past construction examples can be used for a new system construction. However, according to the above conventional construction technique, even if a configuration drawing is drawn, there is no choice but to depend on marks and memos to show the relations between their elements. Since marks and memos are subject to personal laws, thus even if the eyemark is standardized, it is eventually necessary to pick out the changing points upon reuse. That is, past construction examples can not be reused because of their inadequate generalization, thus being unable to improve the working efficiency in the construction of a similar new system.

Thirdly, when constructing a new system reusing past system construction examples, there is no choice but to depend on human hands to change configuration drawings and configuration files, therefor, it isn't free of human errors. As mentioned above, past construction examples are not generalized, it is necessary upon reuse to pick out changing points manually and fill in changes. Let alone a significant workload by human hands, manual works necessarily bring about mistakes. Usually, such mistakes are postal errors of characters and symbols or incompleteness of the picking of changing points, which are difficult to find. In a large-sized system, the number of changing points is great and the changing points go into detail, thus mistakes are very likely to be interjected.

In addition to the above problems and despite a strong demand for the system construction adapting to the Internet, it is difficult to find and retain IT engineers who are equipped with the necessary knowledge. Though a lack of IT engineers could be coped with via necessary education and training, it is evident that such a lack is the inhibiting factor for providing quick and adequate construction services.

Moreover, even an excellent IT engineer might not easily keep pace with the speed of progress of the Internet technology. In the IT field that makes progress day-by-day, there is always a new service arising, wherein such a new service should be incorporated rapidly.

### OBJECTS OF THE INVENTION

It is therefor an object of the present invention to improve working efficiency in system construction. Another object of the invention is to reduce the workload for creating a configuration drawing. A further object of the invention is to provide a system which can perform consistently from the creation of a configuration drawing to the creation of a configuration file. A still further object of the invention is to provide a means for easily correcting and changing configuration drawings and configuration files. A yet further object of the invention is to provide a technique for suppressing mistakes getting interjected into the creation step of configuration drawings and configuration files. A further object of the invention is to provide a means for generalizing the completed configuration drawings that are the past system construction examples. A further object of the invention is to provide a means for effectively using the past construction examples. A further object of the invention is to provide a means for enabling a high-level system construction with a required minimum knowledge. An additional object of the present invention is to provide a means for coping with a technology such as a new service.

### SUMMARY OF THE INVENTION

The above and other objects of the invention will be met by the invention as described within. The system construction method of the present invention comprises the steps of: creating a system configuration drawing using a system configuration editor; automatically generating a system configuration file including attribute data that is generated or input by the system configuration editor; and installing the configuration file into the system. According to such a system construction method, it is possible to create a configuration drawing efficiently using the system construction editor. Also it is possible to perform consistently from the creation of a system configuration drawing to the creation of a configuration file, since the configuration file is generated automatically. The step of creating a configuration drawing using a system configuration editor comprises the steps of: specifying a component and generating the component in the drawing screen of the system configuration editor; associating the component to other components; and inputting properties of the component. An action for associating components comprises inclusion or superposition of a component, generation of connecting lines, etc. A component is a logical service or piece of software or hardware, which is an element that is registered in advance. A user can simply display a graphic of service or the like by selecting such a component. Further, as the component is associated with other components, it is unnecessary to redraw a connecting line between components due to the movement, enlargement, reduction, etc., of the components. Hence, the working efficiency can be increased. In addition, properties are defined to every component, so that the relations between components and environmental unique values specific to a component (service or hardware) are described by the properties. As the properties pertain to a component, when the relation between the components changes structurally, it is possible to change the properties so as to reflect that structure.

In generation of a component, default data may be input to a part of the attribute data of the component. This increases the convenience of user input operation. The default data includes an influence area of the component and a reference point of the component.

In the step of generating a component or the step of associating components, if all or part of the component are included within an influence area of any other component, then a part of attribute data of the component can inherit the attribute data of the other component.

In the step of inputting properties, it is possible to restrict properties that can be input to a part of properties that can be associated with the components. This allows omitting unnecessary properties, which allows even a person who has a required minimum knowledge to construct a standard system configuration using the present configuration editor. That is, a user simply needs to input values referring to the input screen for properties in order to input values to required data fields, which configures a standard system automatically. In other words, required values are manifested in the property screen, which plays an assistant role upon consulting activities.

The step of automatically generating a configuration file comprises one of the steps of: replacing a shadow property included in the configuration file template with a property that is specific to the system; expanding a macro function included in the configuration file template recursively and replacing a property specified in the macro function with a property that is specific to the system; and expanding recursively according to a macro control statement included in the configuration file template and replacing the shadow property or the property specified in the macro function with a plurality of properties specific to the system. This allows automatically generating a configuration file with incorporating input data into the configuration editor. The configuration file template is created in advance in view of components such as a service, such that a standard configuration file is generated using a macro language. The configuration file template is provided for every product version in view of product versions that are used in the system.

After the step of automatic generation of a configuration file, the configuration file can be corrected in relation to the restricted properties. Also, for a customer, a system construction agency can conduct a consultation about a system construction, create a configuration drawing and install a configuration file to the system.

### BRIEF DESCRIPTION OF THE DRAWINGS

FIG. 1 is a block diagram conceptually showing an example of a system construction method of the embodiment of the present invention.

FIG. 2 is a flowchart of a sequence of a system construction method according to the embodiment of the present invention.

FIG. 3 is a block diagram conceptually showing another example of a system construction method.

FIG. 4 is a block diagram conceptually showing a further example of a system construction method.

FIG. 5 is a block diagram showing an example of a system that implements the e-editor of the present invention.

FIG. 6 is a flowchart of an example of drawing method by the e-editor.

FIG. 7 is a diagram showing an example of display screen after the activation of the e-editor.

FIG. 8 depicts an example of a display screen after some degree of drawing (design) work has proceeded.

FIG. 9 is a block diagram of an example of a configuration file generation system according to the embodiment of the present invention.

FIG. 10 is a block diagram of an example of a function of a configuration file generation system according to the embodiment of the present invention.

FIG. 11 is a flowchart of an example of configuration file generation method.

FIG. 12 is a block diagram of another example of a system construction method according to the present invention.

### DETAILED DESCRIPTION OF A PREFERRED EMBODIMENT

Now an embodiment of the present invention will be described referring to the attached drawings. The present invention can be implemented by numerous different forms, so it is not limited to the embodiments described herein. It is noted that the same reference numbers are used for the same elements throughout the drawings.

The present invention will be mainly described as a method and system, however, as is understood by those skilled in the art, the present invention is also implemented as a medium that records a program code usable in a computer. Further, the present invention is implemented as software, that is, a sequence of processing instructions or data (i.e., program codes) that is decoded by a computer. Therefor, the present invention can take a form of hardware, software, and a combination thereof. A medium that records program codes is any computer readable medium, including a hard disk, CD-ROM, optical storage, magnetic storage, etc.

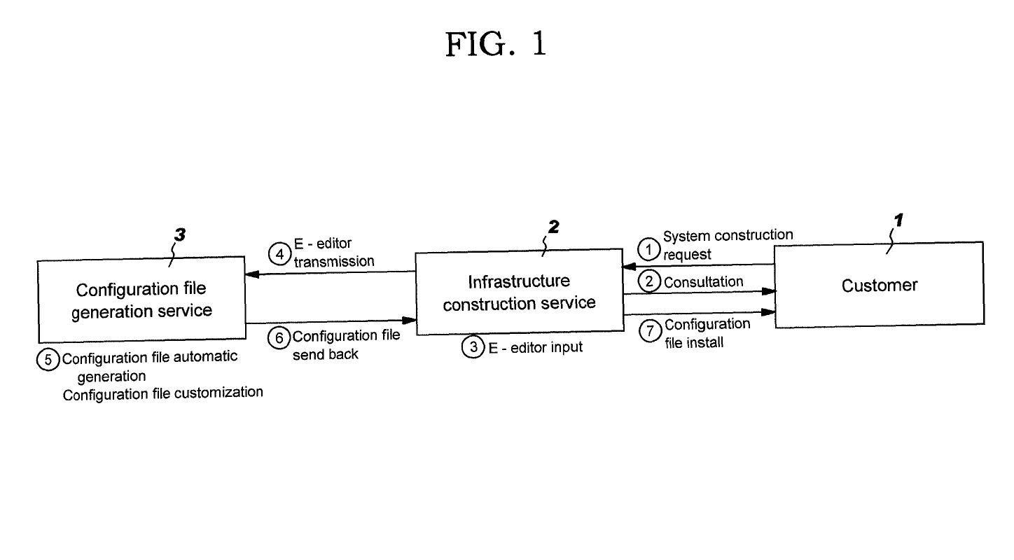

FIG. 1 is a block diagram conceptually showing an example of a system construction method of the embodiment of the present invention. The system construction method comprises customer 1, an infrastructure construction service 2, and a configuration file generation service 3. The customer 1 is a person who desires the system construction of a network system or the like, including companies and individuals that perform a business activity, for example. The customer 1 does not construct the system by himself, but attempts to entrust an external agency with a system construction. A provider of an infrastructure construction service 2 is a person who is entrusted with the work about a system construction from the customer 1. The Provider 2 conducts a consultation for the customer 1 and assists the customer 1 who does not have enough knowledge about system construction. The configuration file generation service 3 is a facility that automatically generates a configuration file that the infrastructure construction service 2 can use, putting functions together that require an advanced knowledge, including a function to cope with the latest technologies such as a component described below, an error report of file generation, etc. Hence, the infrastructure construction service 2 can get the latest and advanced information from the configuration file generation service 3. In addition, the provider of the infrastructure construction service 2 is not required an advanced knowledge since the technical supports are expected.

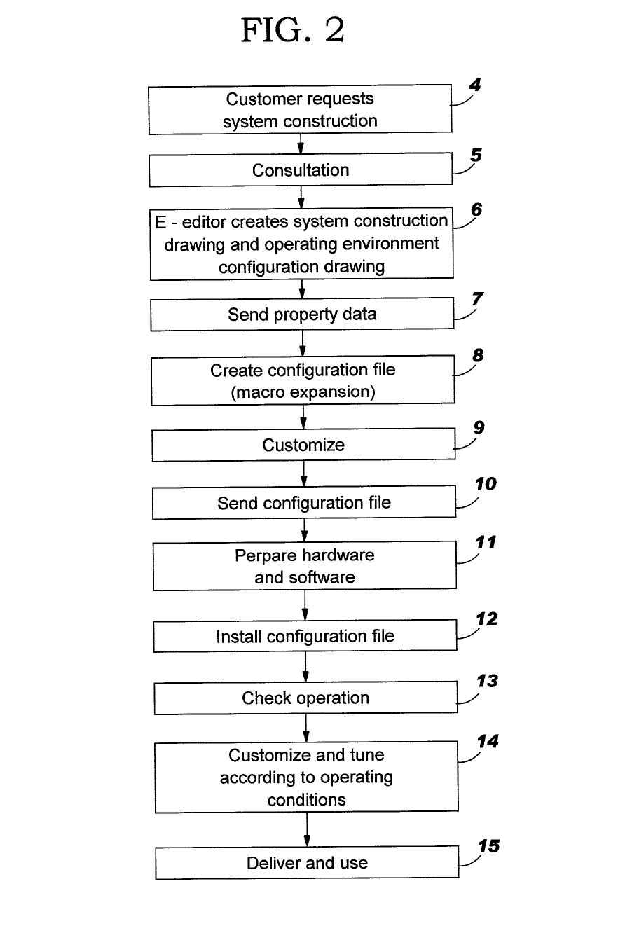

FIG. 2 is a flowchart of a sequence of a system construction method according to the embodiment of the present invention. First, the provider of the infrastructure construction service 2 receives a request for system construction from the customer 1 (step 4). Next, the provider of the infrastructure construction service 2 conducts a consultation for the customer 1 (step 5). Upon this consultation, the customer 1 requires the service he needs, or he gets information necessary for his own system construction from the presentation by the provider. The service provider comprehends the needs of the customer 1 and gets information that forms the foundation of the system design. Thereafter, the provider of the infrastructure construction service 2 performs the system design work using a system configuration editor (e-editor)(step 6).

The e-editor facilitates the creation of system configuration drawings (including logical system configuration drawings, physical system configuration drawings, operating environment configuration drawings), as mentioned later. Thus, it can reduce the workload of the designer. Also, the e-editor describes relations between components such as a shown service. Thus, with such operations as generation and movement of components, the description of relations by means of connecting lines is automatically redrawn, for example. Also, the e-editor has properties for every component and can describe values specific to components by properties. This allows automatically generating the configuration files, with providing values (properties) included in the property list to the configuration file generation server. Further, restricting items displayed in the property list, the provider of the infrastructure construction service 2 can easily conduct a consultation. A consultant only needs to conduct a consultation so as to collect necessary information for filling in blank fields in the property list, so that a consultant who does not have an advanced knowledge about system construction can design a system that meets certain customer satisfaction requirements. This allows many human resources to be used as a consultant without experiencing an education and training curve that requires significant time and expense.

Input Data (property values) to the property list of the e-editor is sent to the configuration file generation server (the configuration file generation service 3)(step 7). The server that received properties records them and expands the configuration file template using the macro engine in the server. In the macro expansion, the configuration file is generated by incorporating the received property values (input information) (step 8). As the configuration file is automatically generated by the macro expansion, no input mistakes occur relating to the system's unique values (part of properties). This allows the reduction in work for picking out mistakes at the working step, thereby increasing the working efficiency. Also, as mentioned later, a lack of data that is necessary for the macro expansion, a lack of logical consistency between components, etc., are found. These results are returned to the infrastructure construction service 2 as an error report, which assists in finding mistakes at the input step to the e-editor.

The generated configuration file is customized as needed (step 9). If there is data that is not displayed in the property list of the e-editor, the customization enables their display. As mentioned above, properties displayed in the property list of the e-editor are restricted to the minimum. This restriction facilitates the consultation by the service provider. However, it is impossible to meet the detailed demands of the customer if default values are assigned to properties other than those displayed in the property list. For this reason, this is enabled with manual customization. This customization requires an advanced knowledge, thus it is preferably performed by the configuration file generation service 3.

The customized configuration file is sent to the infrastructure construction service 2 (step 10). The provider of the infrastructure construction service 2 prepares hardware and system software needed for the system construction, and software such as application software (step 11), and after performing necessary installation and physical connections, installs the configuration file (step 12). At this point, the basic system configuration completes. The service provider checks system operations (step 13), then adds users and groups, and then tunes the security levels or the like according to operating conditions (step 14), finally delivering to the customer 1. The customer 1 uses this system for necessary works (step 15).

According to the system construction method of the embodiment of the present invention, it is consistently performed from the creation of a configuration drawing to the creation of a configuration file. This makes the work efficient by using the e-editor, simplifies the system design, and reduces a factor of inefficiency such as an input mistake. Furthermore, according to the present method, the works that really require an advanced knowledge are put together in the configuration file generation service 3, wherein the infrastructure construction service 2 is expanded under the support system of the configuration file generation service 3. This assists the works of consultants in charge of the infrastructure construction service 2, which allows even a person who does not necessarily have an advanced knowledge to provide a high-quality service environment for infrastructure construction. The system construction method and system of the present invention can rapidly provide a high-quality infrastructure construction service by optimizing the capacity of those who engage in the system construction services and labor resources.

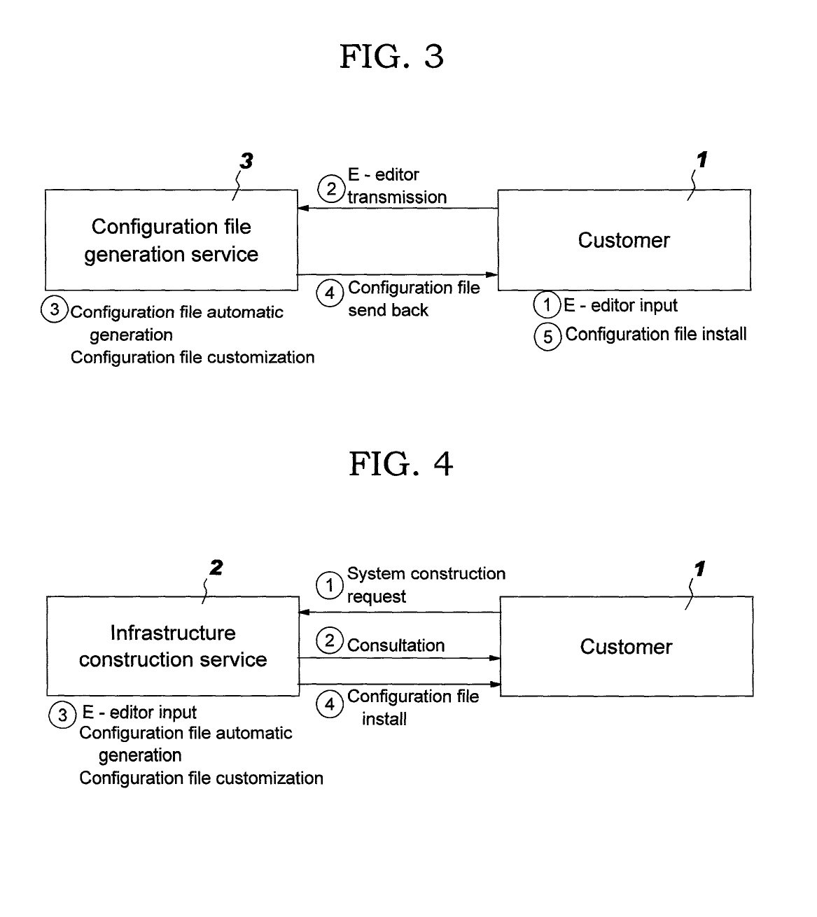

It is noted that the customer 1, the infrastructure construction service 2 and the configuration file generation service 3 were described to be a separate and independent entity, however, the customer 1 may access the configuration file generation service 3 directly, as is shown in FIG. 3. In this case, it is assumed that the customer 1 is distributed the e-editor, wherein the customer 1 inputs to the e-editor by himself. In this case, the customer 1 should have a certain degree of knowledge, requiring consultation about system construction. Alternatively, the infrastructure construction service 2 and the configuration file generation service 3 may be embodied by the same business entity, as is shown in FIG. 4.

Next, the system that embodies the e-editor and the drawing method by the e-editor will be described. Note that the computer used in the embodiment of the present invention may be a typical one, which includes a Central Processing Unit (CPU), a main memory (RAM), a nonvolatile storage (ROM), etc., all of which are interconnected by bus. Also connected to the bus are co-processors, an image accelerator, a cache memory, an input/output (I/O) controller, an external storage, a data input device, a display device, a communication controller, etc. Hardware resources that are generally provided for a computer system may also be provided. The data input devices include an input device, such as a keyboard, and an auxiliary input device, such as a mouse and pointing device. The display device includes a CRT, an LCD, a plasma display, etc. A computer system includes a various kinds of computers, such as a personal computer, a workstation and a mainframe computer. A processing described later may be processed dispersively. For example, a part of a program could be processed on the user's computer, while the remaining part of the program could be processed on a remote computer dispersively. With regard to data used in a program, it doesn't matter on which computer it is recorded. As long as information about a location of data is clear and its data is available, a location where the data or programs are stored may be anywhere on the computer network. Any well known communication technology can be applied to a communication between each network computer, for example, TCP/IP and HTTP protocols may be used. An address of each file (data or program) that may be recorded in each storage is specified using DNS, URL, etc. Note that the term “the Internet” used herein implies an intranet or extranet as well. A phrase “access to the Internet” implies accessing to an intranet or extranet as well. The term “computer network” implies a computer network that can be publicly accessed or a computer network that can only be accessed privately.

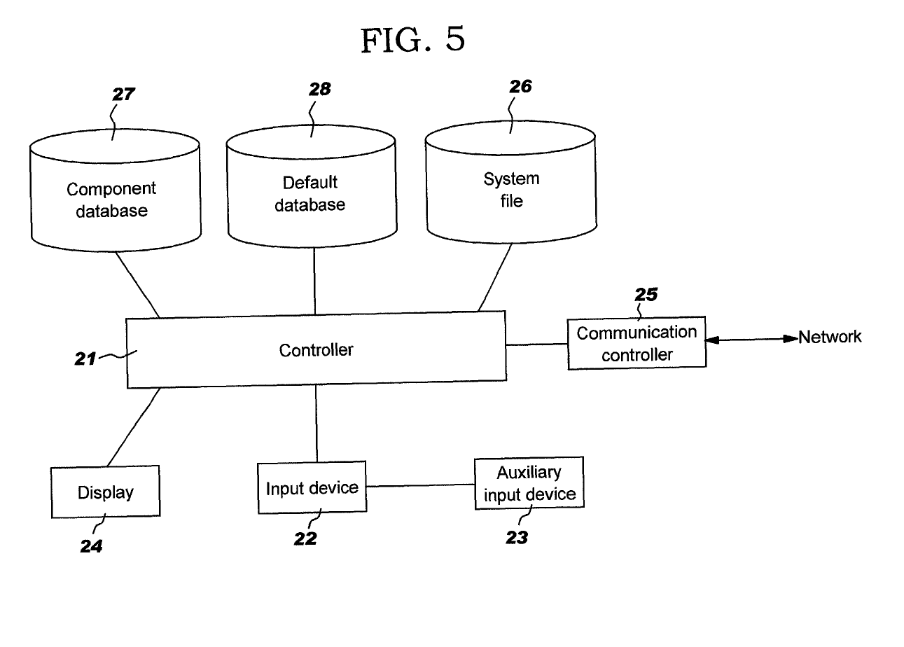

FIG. 5 is a block diagram showing an example of a system that implements the e-editor of the present invention. A controller 21 such as a CPU is connected to an input device 22, an auxiliary input device 23, a display device 24, a communication controller 25 and comprises a system file 26, a component database 27, and default database 28.

The controller 21 controls a computer system that executes the e-editor. For example, it receives an input signal from the input device 22 or auxiliary input device 23 to control edit or input functions of the e-editor. Alternatively, it controls displaying display data or graphics to the display device 24, or controls data communication via the communication device 25.

The system file 26 includes software that implements the e-editor, as well as system software of the computer system and data needed for system control. The e-editor software is read and executed by the controller 21.

The component database 27 stores definition files of components. The definition file defines a component number, a component name, the number of properties, which is followed by property names corresponding to that number. The following is an example defining three tools (components), i.e., a domain framework, a subnet framework, and a server framework.

“[”0, “Domain”,2,“]”

“ . . . <”, “Domain:”, “> . . .”

“ . . . <”, “Network:”, “> . . . ”

“[”,1“Subnet”, 2, “]”

“ . . . <”, “Subnet:”, “> . . . ”

“ . . . <”, “Mask:“,” > . . . ”

“[”2, “H/W”, 2, “]”

“ . . . <”, “Host Name:”, “> . . .”

“ . . . <”, “IP Address:”, “> . . . ”

“Domain Name” and “Network Address” are defined as a property of the domain framework, “Subnet Address” and “Address” are defined as a property of the subnet framework, and “Host Name” and “IP Address” are defined as a property of the server framework.

According to such a definition file, it becomes easy to add properties to a component and to add a new component, etc. The definition file of components is read under the control of the e-editor software and displayed as an icon in the component box, as described later.

In the default database 28, there are stored default values of each component. Default values are applied as a property upon generating each component.

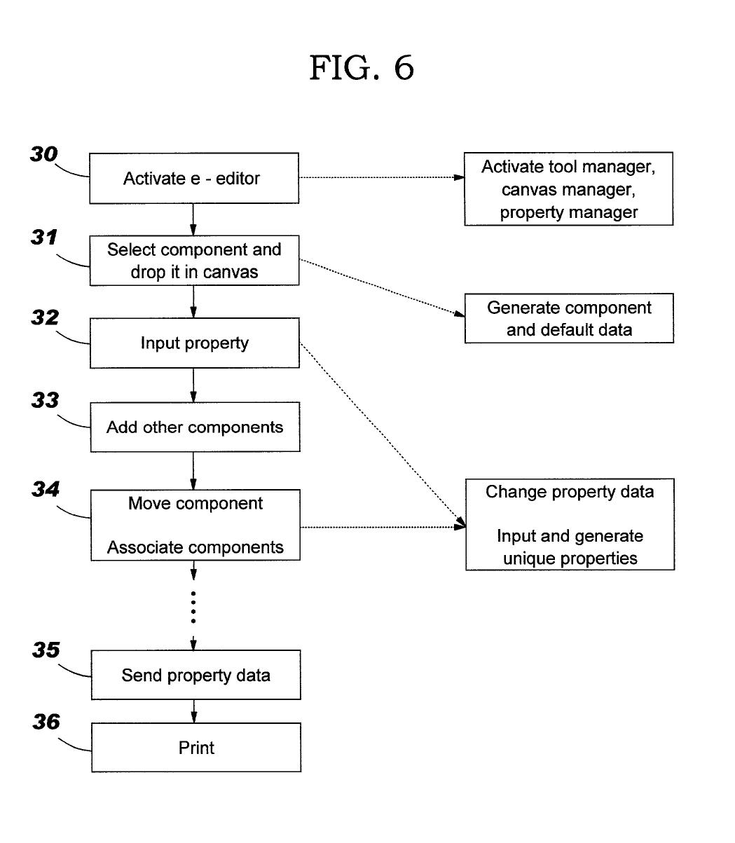

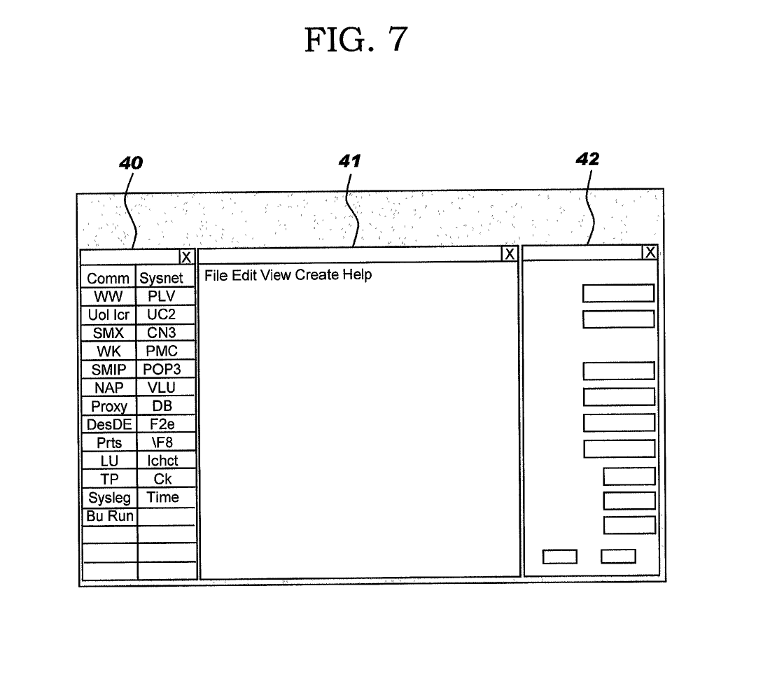

FIG. 6 is a flowchart of an example of a drawing method by the e-editor. First, the e-editor is activated (step 30). Next, the tool manager, the canvas manager and the property manager are activated due to the activation of the e-editor. FIG. 7 is a diagram showing an example of a display screen after the activation of the e-editor. There is displayed each screen frame on the display screen of the display 24, including the tool box 40 that is generated and displayed by the tool manager, the canvas 41 that is generated and displayed by the canvas manager, and the property list 42 that is generated and displayed by the property manager.

There are displayed in the tool box 40 the components that comprise the network system with their icons. A component includes a domain framework (Domain), a subnet framework (Subnet), hardware (H/W), etc. A component can be added and deleted by rewriting the definition file, as is mentioned above, wherein the contents of the definition file are read by the component manager and reflected in the tool box 40.

The canvas 41 is a screen for drawing and displaying graphics. A graphic that corresponds to the generated component is drawn in the canvas 41, wherein any graphic can be edited for movement, enlargement and reduction on the canvas 41.

There are displayed in the property list 42 the properties of components that are currently selected. There are properties that can be generated automatically and can not be changed, including component number, for example. There are also properties that can be generated automatically, but can be changed, including component name, for example. Further, there are properties that can not be generated automatically and need to be input.

After the activation of the e-editor, a user (i.e., a system construction worker) selects a component from the tool box 40 and generates and draws a graphic of the component in the canvas 41 by, for example, drag and drop of the component icon with a mouse (step 31). An icon dropped in the canvas screen generates a rectangle of the size specified by the default values and draws it in the canvas 41. Also, by clicking some point in the canvas screen with a mouse, a graphic of components may be generated by other command operations such as a key command.

A default value is input to a property of the generated component, in response to this generation. For example, they are a serial number, a component name, etc. In addition, coordinates of the graphic are input depending on the location in the canvas 41 where the component occurs, further a reference point, a color, a font, etc., are input. Default values are predetermined for every component, which are recorded in the default database 28.

Coordinates of the graphic generated as a property not only specify the location and size of the graphic, but also the influence area of the component. Further, the reference point is generated somewhere on the periphery of the graphic and functions as a point that represents the component represented by that graphic. The reference point can be moved to any position on the periphery. That is, when a reference point of some component is within an influence area of any other component, that component is influenced by the other component. For example, if a reference point of some DHCP (Dynamic Host Configuration Protocol) is within an influence area of a subnet framework having “192.168.10” as a property value, that DHCP operates within a subnet “192.168.10”. In this case, the property value “192.168.10” of the DHCP is automatically generated or changed when it is generated or moved within the subnet framework.

When the component is hardware, the reference point of the component represents an interface as well. Hence, it is to have a host name property and an IP address of host section property as a subproperty of the reference point of a property. Further, in case of a component that is contained in a plurality of components, such as a gateway that connects different subnets, a reference point is added. In the above case, a plurality of reference points are provided on the periphery of the gateway framework, wherein each reference point is located within an influence area of each subnet framework. When a service (e.g., DNS) that operates within a hardware framework with a plurality of reference points, provides a service using a plurality of reference points, it is necessary to associate each reference point of the service to each reference point of the hardware and that the subnet framework should have one reference point. When a plurality of hardware reference points (interfaces) exist in the same subnet framework, it needs to be divided into a plurality of subnets that have the same network section property.

Selecting a graphic drawn in the canvas 41, a property of the component represented by that graphic is displayed in the input field of the property list 42. Data is input into the blank fields or the fields that can be changed, thereby inputting property values (step 32).

In this way, a graphic is generated for one component and properties are input, while other components are added in the same way (step 33). Furthermore, a plurality of components are associated with, or a component is moved within an influence area of, any other component to associate them (step 34).

An association is also possible by generating a connecting line showing the relation between components. If a component is a DNS, an association between a source DNS and a destination DNS is performed by inputting the destination DNS into the destination property of the source DNS. The destination DNS may be input by selecting it with a mouse, with property input of the source DNS being active. This association is represented by an arrow from the source DNS to the destination DNS, which is automatically generated by property input.

When moving a component such that a reference point of the component enters within an influence area of any other component, the component is associated with the other component. For example, when moving a DNS within a hardware framework, that DNS is to operate on a server represented by the hardware framework, properties of the hardware that can be applied to the DNS are inherited to the properties of the DNS. For example, in the definition file mentioned above that defines a domain framework, a subnet framework, and a server framework, assuming that a domain framework is drawn and a domain property is set to “ibm.local.com”, a network property is set to “192.168.0.0”, still further a subnet framework is drawn in it and a subnet property is set to “192.168.0.0”, a mask property is set to “255.255.255.0”, yet further a server framework is drawn in it and a host name property is set to “srv01”, an IP address property is set to “192.168.10.10”, the tool (component) such as a DNS that is located in this server framework is added with a upper level of properties such as a server framework and a domain framework automatically.

The above steps are repeated until a desired system is configured. When the design is completed, the operating environment configuration drawing is created. By the way, it is possible to restrict items displayed in the property list 42 to an amount necessary to achieve a basic system configuration. Hereby, the design work will proceed with filling in all property lists. In other words, so long as the property lists are filled in, no more information needs to be collected. This allows even an operator who doesn't have advanced knowledge to clearly comprehend necessary information for a design work, thus facilitating a consultation.

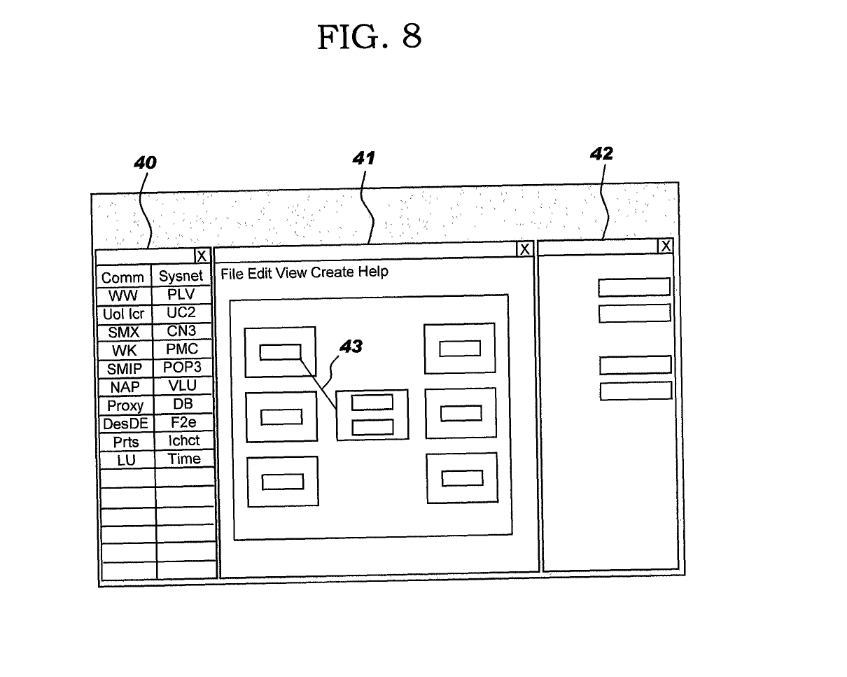

FIG. 8 depicts an example of a display screen after some degree of drawing (design) work has proceeded. There are displayed some components in the canvas 41. For example, a DNS component named as “Internal DNS” is located to operate on the hardware “NetFinity-1”, which is located in a subnet “Partition 1”. The subnet “Partition 1” is a subnet of the domain “hakozaki LAN”. The subnet “Partition 1” and subnet “Partition 2” are connected by the gateway “Gateway”, in which each service of path control and transfer DNS is arranged. The transfer DNS is a destination of the internal DNS, whose relation is represented by the connecting line 43. The display of the property list 42 shows properties of the internal DNS, wherein the destination property is filled with “DNS002” (i.e., transfer DNS).

When the configuration is completed as described above, the property values are sent to the configuration file generation server (step 35). The configuration drawing is printed as needed (step 36).

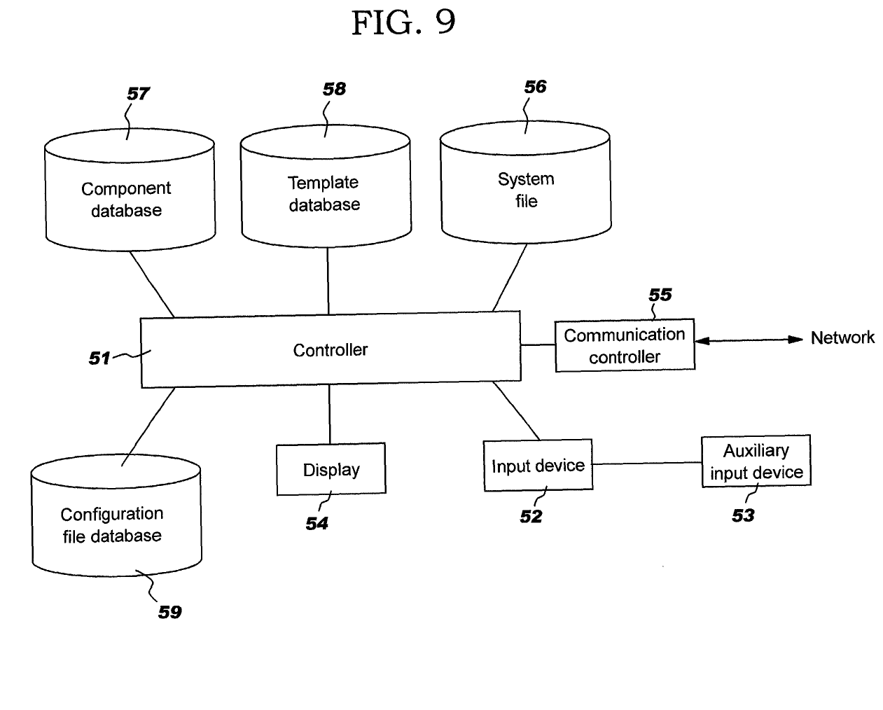

Next, the method and system for generating a configuration file will be described. FIG. 9 is a block diagram of an example of a configuration file generation system according to the embodiment of the present invention. As with the aforementioned e-editor, this system comprises a controller 51, an input device 52, an auxiliary input device 53, a display device 54, a communication controller 55, a system file 56, a component database 57, a template database 58, and a configuration file database 59.

The controller 51, input device 52, auxiliary input device 53, display device 54, communication controller 55, system file 56, and component database 57 are about the same as the above-mentioned, thus will not be described here. However, they are used for generating a configuration file rather than e-editor here. Further, a newly provided component is registered with the component database 57. This component is provided to the e-editor as needed.

The template database 58 stores the after-mentioned templates. The configuration file database 59 stores configuration files that are completed as a system construction example.

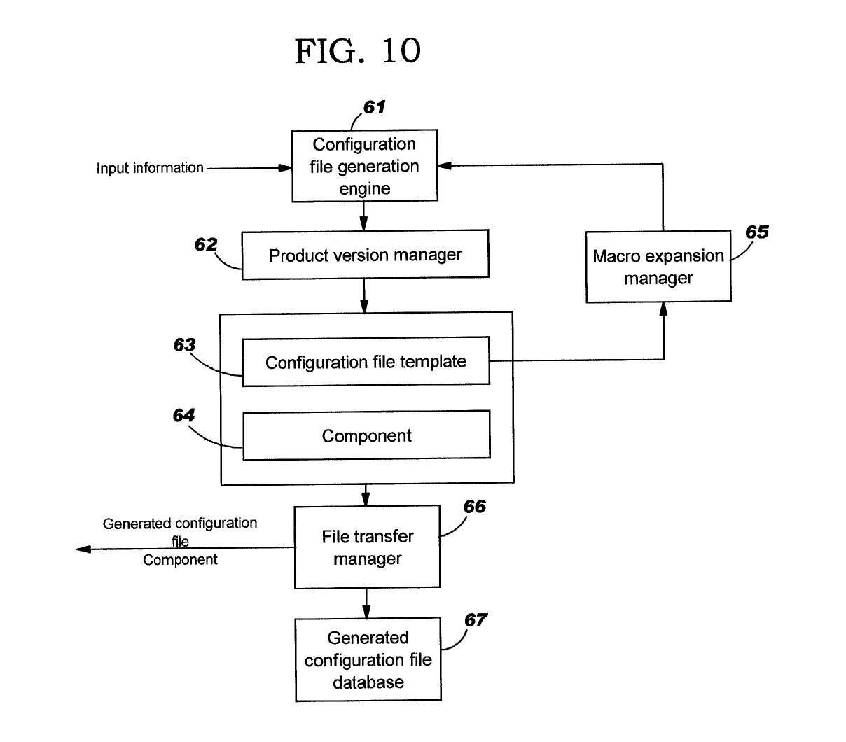

FIG. 10 is a block diagram of an example of a function of a configuration file generation system according to the embodiment of the present invention. A configuration generation engine 61 receives input information (property data) from the e-editor and performs a macro expansion as described later.

A product version manager 62 reads a product that is used in a system to be configured and its version from the input information, and selects a template that is used in the macro expansion. As the grammar and notation of the configuration file to be generated depend on the product where it is installed (for example, OS products such as UNIX, Windows NT, Linax, etc.), a template file for the macro expansion needs to be prepared for every product version in order to generate a configuration file that matches each product and its version. The product version manager 62 has a function to select an optimum template.

A configuration file template 63 is a prototype file of a configuration file, which describes elements to be replaced with the macro expansion in a state of shadow property. Various kinds of templates need to be prepared for every product version. A property that corresponds to a shadow property is a property that can be input by the e-editor. The number of properties that can be input increases, elements to be replaced with macro expansion increase, which makes the development difficult. However, there are only a limited number of properties that frequently encounter a change request, so that the majority of properties rarely demand a change. Hence, rather than creating a huge template that can cope with all properties, it is preferable, for increasing the working efficiency, to create a template in a compact manner by only considering properties that frequently encounter a change request as the subject of macro expansion, while excluding properties that rarely demand a change from the subject of macro expansion. Concerning the properties that can not be converted by the macro expansion, they are to be processed manually, which doesn't so much decrease the working efficiency as the frequency of their change requests is low as described above.

A component 64 is the same as the one in the case of the e-editor. However, the component 64 in the configuration file generation server is the one that always reflects a new technology. It also functions as a master file that might be distributed to the e-editor. The component 64 is referred to upon macro expansion.

A macro expansion manager 65 expands the template with macro expansion using input information and product version information. A file transfer manager 66 has functions to transfer the completed configuration file to the e-editor and to distribute the latest components. A generated configuration file database 67 stores the completed configuration file as a system construction example.

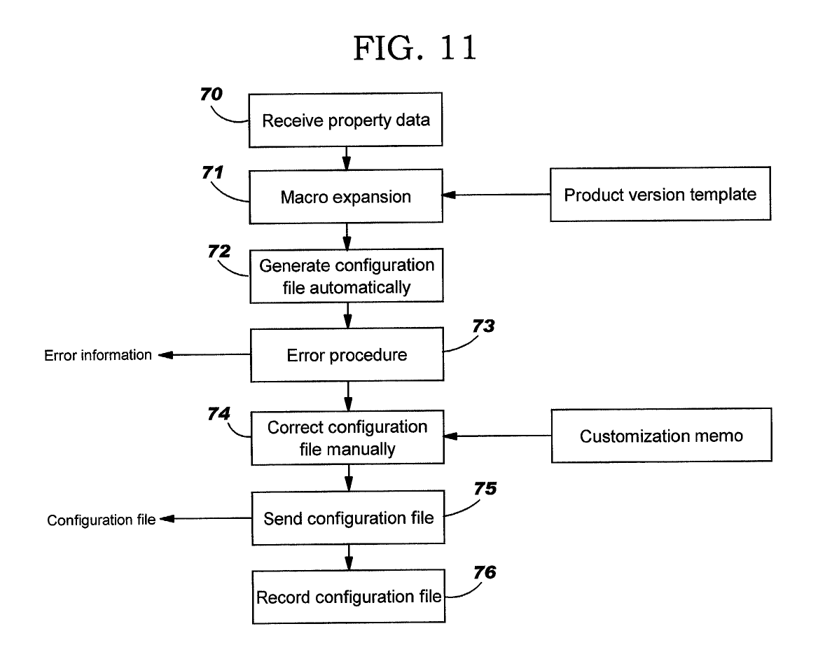

FIG. 11 is a flowchart of an example of a configuration file generation method. First, the configuration file generation server receives property data from the e-editor (step 70). Thereafter, it expands a template 63 with macro expansion according to the product version using the received property data (i.e., input information to the e-editor)(step 71). As mentioned above, a template describes a portion to be replaced for the input properties with shadow properties. A shadow property is described with a token “_# #_”, such as “_#property name #_”. A macro engine identifies this token, searches for it using a property name, and replaces a portion surrounded by tokens with a corresponding property value. For example, if a property name “HOSTNAME” is described in the template as follows,

HOSTNAME=_# HOSTNAME #_{—}

and a property value corresponding to a property name “HOSTNAME” is “srv0”, then the following result is generated in the configuration file after the macro expansion.

HOSTNAME=srv01

Furthermore, a technique typified by the transparency of SNA can be used to prevent tokens from butting. For example, a template is described as follows,

HOSTNAME=_# HOSTNAME #_/*_#_# MATSUO #_#_*/

In this case, the conversion results in the following.

HOSTNAME=svr01/*_# MATSUO #_*/

When it is needed to process a property as an IP address network section in the reverse zone of DNS, a macro function can be provided. A macro function is described with “_# function name (function or variable name) #_”. For example, if a template is described as follows,

zone “_# REVERSE(IP_NETWORK) #_.in-addr.arpa”

and an address of a network portion that the DNS covers is “192.168.10”, then the following result is generated in the configuration file after the macro expansion.

zone “10.168.192.in-addr.arpa”

A macro control statement may be prepared to control repetitions and branches due to conditions, in order to be expanded into a plurality of property values. A macro control statement is described with _# control statement (function name (function or variable name or condition) _#. For example, if a template is described as follows,

_# IF_START (FORWARD_NUM <> 0) #_{—}

forwarders {

_# LOOP_START (FORWARD_NUM) #_{—}
_# FORWARD_IPADDRESS #_{—}
_# LOOP_END #_{—}

}

_# IF_END #_{—}

and there are two properties svr01 (whose IP address property is 192.168.10.1) and svr02 (whose IP address property is 192.168.10.2) as a DNS destination property, then the following result is generated in the configuration file after the macro expansion.

forwarders {

192.168.10.1;
192.168.10.2;

}

In this way, a template is described using a token and expanded with macro expansion. This allows a shadow property to be replaced with a corresponding property value, thereby generating a configuration file automatically (step 72).

By the way, there may be an instance where a lack of property data or a logical contradiction is found during a macro expansion. In this case, an error procedure is performed (step 73), which informs the e-editor of error information. If no error occurs, the process goes to step 74.

In step 74, the configuration file is corrected manually. At this point, a customization memo that was acquired at the consulting step is referred to. As described above, the configuration file generation system of the present invention does not cope with all properties, thus properties that could not be automatically generated need to be changed and input manually. Then, the completed configuration file is sent to the computer system of the e-editor (step 75), the configuration file is stored in the configuration file database 59 (step 76), and the processing is ended in the configuration file generation server.

In this way, according to the configuration file generation server of the present invention, the major part of a configuration file is automatically generated.

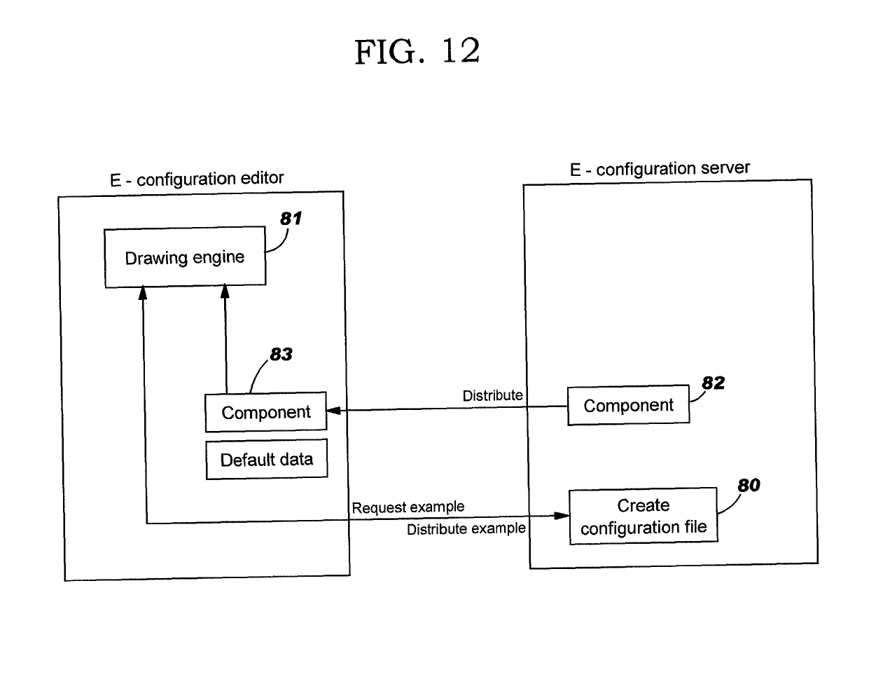

Moreover, as is shown in FIG. 12, a created configuration file 80 that is stored in the configuration file generation server can be distributed according to the request from the drawing engine 81 in the e-editor. The distributed configuration file is referred to by an operator (i.e., system designer) as a system construction example. In addition, the configuration file generation server updates a component 82 that copes with the latest technologies and properly distributes it to the e-editor. The e-editor replaces its own system component 83 with the distributed component or adds a difference between them.

The present invention has been described according to the preferred embodiments, however, it is not limited to the forgoing embodiments and various modifications, changes and substitutions are contemplated without departing from the spirit and scope of the present invention.

For example, in the above embodiment, an installation of the configuration file to the construction system is performed by a provider of the infrastructure construction service, however, it is also possible to send a configuration file installation program in executable form to a customer directly from the configuration file generation server by means of e-mail or the like, and to install the configuration file automatically.

Also, the e-editor may provide for not only the aforementioned functions for movement and enlargement or reduction of a graphic, but other graphic edit functions such as grouping.

As mentioned above, according to the present invention, the following advantages are achieved, that is, improving working efficiency in system construction works; reducing the workload for creating a configuration drawing; providing a system which can perform consistently from the creation of a configuration drawing to the creation of a configuration file; providing a means for easily correcting and changing configuration drawings and configuration files; suppressing mistakes getting mixed in the creation step of configuration drawings and configuration files; providing a means for generalizing the completed configuration drawings that are the past system construction examples; effectively using the past construction examples; enabling a high-level system construction with a required minimum knowledge; and providing a means for coping with a technology such as a new service.

What is claimed is:

1. A method for constructing a system, comprising the steps of:
in response to a specification of a component provided by a system configuration editor, generating said component in a drawing screen of said system configuration editor, wherein said component comprises said system;
associating a plurality of said components by having said component be included in any other component or superposing said component on any other component, or by responding to an operation that generates a connecting line that associates said components;
recording attribute data that is input as a property of said component; and
automatically generating a configuration file of said system from said attribute data and a configuration file template;
wherein the step of automatically generating a configuration file comprises one of the steps of:
replacing a shadow property included in said configuration file template with a property specific to said system included in said attribute data;
expanding a macro function included in said configuration file template recursively, and replacing a property specified in said macro function with a property specific to said system; and
expanding recursively according to a macro control statement included in said configuration file template, and replacing said shadow property or the property specified in said macro function with a plurality of properties specific to said system.

2. The method according to claim 1, wherein the step of generating said component further comprising the step of:
inputting default data to a part of attribute data of said component, wherein said default data includes an influence area of said component and a reference point of said component.

3. The method according to claim 2, wherein in the step of generating a component or in the step of associating said components, if all or part of said component is included within an influence area of any other component that is generated or associated, then a part of attribute data of said component inherits the attribute data of said other component.

4. The method according to claim 1, wherein the step of automatically generating said configuration file further comprising the step of:
referring to information about a product version used in said system, and selecting a configuration file template that matches said product version.

5. A system for constructing a system, comprising:
means for providing components of said system;
means for displaying said components and relations between said components and editing an arrangement of said components;
means for generating or inputting and displaying properties of said components; and
means for receiving said properties that are generated or input as attribute data of said components and automatically generating a configuration file of said system;
wherein the means of automatically generating a configuration file comprises one of following means:
replacing a shadow property included in said configuration file template with a property specific to said system included in said attribute data;
expanding a macro function included in said configuration file template recursively, and replacing a property specified in said macro function with a property specific to said system; and
expanding recursively according to a macro control statement included in said configuration file template, and replacing said shadow property or the property specified in said macro function with a plurality of properties specific to said system.

6. The system according to claim 5, further comprising means for generating said configuration drawing, comprising:
means for generating default data as a part of attribute data of said component, wherein said default data includes an influence area of said component and a reference point of said component; and
means for associating a plurality of said components by generating, moving or changing said component, such that said component is included in any other component or said component is superposed on any other component, or by generating a connecting line that associates said components.

7. The system according to claim 6, wherein the means for generating said component or the means of associating a plurality of said components further comprising, if all or part of said component that is generated or associated, is included within an influence area of any other component, then a part of attribute data of said component inherits the attribute data of said other component.

8. The system according to claim 5, wherein the means for automatically generating said configuration file further comprising:
means for referring to information about a product version used in said system, and selecting a configuration file template that matches said product version.

9. A method for drawing a system configuration drawing, comprising the steps of:
in response to a specification of a component of said system, generating said component in a drawing screen;
associating a plurality of components by having said component be included in any other component or superposing said component on any other component, or by responding to an operation that generates a connecting line that associates said components; and
recording attribute data that is input as a property of said component.

10. The method according to claim 9, wherein the step of generating said component further comprising the step of:
inputting default data to a part of attribute data of said component, wherein said default data includes an influence area of said component and a reference point of said component.

11. The method according to claim 9, wherein in the step of generating said component or in the step of associating components, if all or part of said component that is generated or associated, is included within an influence area of any other component, then a part of attribute data of said component inherits the attribute data of said other component.

12. The method according to claim 9, further comprising the step of inputting said property, wherein properties that can be input are restricted to a part of properties that can be associated with said component.

13. A system for drawing a system configuration drawing, comprising:
means for providing components of said system;
means for displaying said components and relations between said components and editing an arrangement of said components; and
means for inputting and displaying properties of said components.

14. The system according to claim 13, further comprising:
means for, in response to the generation of said component, generating default data as a part of attribute data of said component, wherein said default data includes an influence area of said component and a reference point of said component; and
means for associating a plurality of said components by generating, moving or changing said component, such that said component is included in any other component or said component is superposed on any other component, or by generating a connecting line that associates said components.

15. The system according to claim 13, wherein the means for generating said component or the means of associating a plurality of said components further comprising, if all or part of said component that is generated or associated, is included within an influence area of any other component, then a part of attribute data of said component inherits the attribute data of said other component.

16. The system according to claim 13, wherein the means for inputting and displaying properties further comprising means for restricting properties that can be input to a part of properties that can be associated with said component.

17. A method for generating a configuration file of a system, comprising the steps of:
receiving attribute data of components that comprise said system;
referring to information about a product version used in said system, and selecting a configuration file template that matches said product version; and
expanding said configuration file template with macro expansion.

18. The method according to claim 17, wherein the step of expanding said configuration file template comprises one of the steps of:
replacing a shadow property included in said configuration file template with a property specific to said system included in said attribute data;
expanding a macro function included in said configuration file template recursively, and replacing a property specified in said macro function with a property that is specific to said system; and
expanding recursively according to a macro control statement included in said configuration file template, and replacing said shadow property or the property specified in said macro function with a plurality of properties specific to said system.

19. A system for generating a configuration file of a system, comprising:
means for receiving attribute data of components that comprise said system;
means for referring to information about a product version used in said system, and selecting a configuration file template that matches said product version; and
means for expanding said configuration file template with macro expansion.

20. The system according to claim 19, wherein the step of expanding said configuration file comprises one of the steps of:
replacing a shadow property included in said configuration file template with a property specific to said system included in said attribute data;
expanding a macro function included in said configuration file template recursively, and replacing a property specified in said macro function with a property that is specific to said system; and
expanding recursively according to a macro control statement included in said configuration file template, and replacing said shadow property or the property specified in said macro function with a plurality of properties specific to said system.

21. A computer-readable recording media recording a program for causing a computer to draw a system configuration drawing, the program comprising:
a function for, in response to a specification of a component of said system, generating said component in a drawing screen;
a function for associating a plurality of components by having said component be included in any other component or superposing said component on any other component, or by responding to an operation that generates a connecting line that associates said components; and
a function for, in response to an input of properties of said component, recording said input values as attribute data of said component.

22. A computer-readable recording media recording a program for causing a computer to generate a configuration file, the program comprising:
a function for receiving attribute data of components that comprise said system;
a function for referring to information about a product version used in said system;
a function for selecting a configuration file template that matches said product version; and
a function for expanding said configuration file template with macro expansion;
wherein the function for expanding said configuration file template comprises one of the following means:
means for replacing a shadow property included in said configuration file template with a property specific to said system included in said attribute data;
means for expanding a macro function included in said configuration file template recursively, and replacing a property specified in said macro function with a property specific to said system; and
means for expanding recursively according to a macro control statement included in said configuration file template, and replacing said shadow property or the property specified in said macro function with a plurality of properties specific to said system.

23. A computer-readable recording media, comprising:
a function for, in response to a specification of a component of said system, generating said component in a drawing screen;
a function for associating a plurality of said components by having said component be included in any other component or superposing said component on any other component, or by responding to an operation that generates a connecting line that associates said components;
a function for, in response to a input of properties of said component, recording said input values as property data of said component;
a function for receiving attribute data of components that comprise said system;
a function for referring to information about a product version used in said system;
a function for selecting a configuration file template that matches said product version; and
a function for expanding said configuration file template with macro expansion;
wherein the function for expanding said configuration file template comprises one of the following means:
means for replacing a shadow property included in said configuration file template with a property specific to said system included in said attribute data;
means for expanding a macro function included in said configuration file template recursively, and replacing a property specified in said macro function with a property specific to said system; and
means for expanding recursively according to a macro control statement included in said configuration file template, and replacing said shadow property or the property specified in said macro function with a plurality of properties specific to said system.
